(19) United States
(12) Patent Application Publication
(10) Pub. No.: US 2016/0232256 A1
(43) Pub. Date: Aug. 11, 2016

(54) MODEL BUILDER

(71) Applicant: Autodesk, Inc., San Rafael, CA (US)

(72) Inventors: Justin Michael Lokitz, San Francisco, CA (US); Curtis Krone, San Rafael, CA (US); Dong Yang, Alameda, CA (US); Valentin Ofshteyn, San Rafael, CA (US); Anilkumar Kantilal Patel, Kentfield, CA (US); Laurence Thompson Knott, III, Larkspur, CA (US)

(73) Assignee: Autodesk, Inc., San Rafael, CA (US)

(21) Appl. No.: 15/007,997

(22) Filed: Jan. 27, 2016

Related U.S. Application Data
(60) Provisional application No. 62/113,264, filed on Feb. 6, 2015.

(51) Int. Cl. G06F 17/50

(52) U.S. Cl. CPC G06F 17/50

(57) ABSTRACT

A system and method for automatically creating a three-dimensional (3D) model for use in a design application, such as a transportation planning and design application that supports roadway, bridge or drainage design. A user at a client computer selects an area of interest (AOI) on a two-dimensional (2D) map, as well as one or more data sets to be used, and then submits a model creation request to a server computer. The server computer automatically aggregates one or more data sources to generate a 3D model of the area of interest. At least one of the data sources comprises a curated database. The server computer publishes or stores the 3D model into a database, for subsequent downloading to the client computer. The 3D model is a proprietary model owned by the user, and is fully editable by the user.

### CROSS-REFERENCE TO RELATED APPLICATION

This application claims the benefit under 35 U.S.C. Section 119(e) of co-pending and commonly-assigned U.S. Provisional Patent Application Ser. No. 62/113,264, filed on Feb. 6, 2015, by Curtis Krone, Dong Yang, Valentin Ofshteyn, Anilkumar K. Patel, Laurence Thompson Knott III, Justin Michael Lokitz, and Laurie Miu-Fong Ozone, entitled “MODEL BUILDER,” attorney docket number 30566.530-US-P1, which application is incorporated by reference herein.

### BACKGROUND OF THE INVENTION

1. Field of the Invention

The present invention relates generally to computer-aided design applications, and in particular, to a method, apparatus, and article of manufacture for building a proprietary fully editable three-dimensional (3D) and/or two dimensional (2D) model based on a variety of data accumulated from a variety of sources.

2. Description of the Related Art

As the engineering, design, and architecture markets move toward utilizing digital, city-scale 3D models there exists three primary issues: 1) the sources for data that make up visually accurate 3D models, such as infrastructure (above and below ground), terrain, photographic imagery, vegetation, and buildings, are hard to find and often come from disparate data providers; and 2) aggregating source data to create proprietary, realistic, accurate, and editable 3D models is often unwieldy and takes an enormous amount of time. Compounding these issues is that the same data sources plus others are often used for other services, like traffic and watershed simulation and analysis, each of which takes its own inputs and has its own setup.

Accordingly, there is a need to easily produce a fully editable 3D (and/or 2D) proprietary model.

### SUMMARY OF THE INVENTION

Embodiments of the invention solve the problems of the prior art by pre-aggregating available source data and then automatically creating custom 3D models on demand from this data. In accordance with one or more embodiments of the invention, the 3D model supports preliminary engineering for transportation projects, such as roadway design, bridge design or drainage design.

Specifically, a user at a client computer selects an area of interest (AOI) on a 2D map displayed at the client computer, as well as one or more data sets to be used by the server computer in creating the 3D model of the area of interest, and then submits a model creation request for the area of interest to a server computer.

The server computer automatically aggregates one or more data sources, which include both 2D and 3D data, such as vector data and raster data, to generate a 3D model of the area of interest. At least one of the data sources comprises a curated database, the contents of which have been selected, organized, and presented using professional or expert knowledge. For example, the curated database may contain specialized data for roadway design, bridge design, or drainage design.

The server computer builds one or more spatial queries to extract vector data for features within the area of interest from a geospatial database, wherein the vector data includes data for: roadways, bridges, drainage, buildings, railways, waterways, water areas, land-use areas, coastlines or oceans. The server computer also builds one or more spatial queries to identify raster data for features within the area of interest stored in a geospatial database, wherein the raster data includes aerial or terrain raster tiles within the area of interest.

The server computer then creates an empty 3D model, imports the vector data and/or one or more layers of raster data into the empty 3D model, and stylizes the vector data and/or raster data in the 3D model. The server computer may also include other data from external data sources into the 3D model.

The server computer publishes or stores the 3D model into a database, for subsequent downloading to the client computer, where it can be displayed, modified and shared by the user. The resulting 3D model is a proprietary model owned by the user, and is fully editable by the user.

### BRIEF DESCRIPTION OF THE DRAWINGS

Referring now to the drawings in which like reference numbers represent corresponding parts throughout:

FIG. 1 is an exemplary hardware and software environment used to implement one or more embodiments of the invention.

FIG. 2 schematically illustrates a typical distributed computer system using a network to connect one or more client computers to one or more server computers, in accordance with one or more embodiments of the invention.

FIG. 3 is a flowchart illustrating a user experience flow within the client application for building a model, in accordance with one or more embodiments of the invention.

FIGS. 4A-4E illustrate graphical user interfaces (GUIs) displayed by the client application during the user experience flow of FIG. 3, in accordance with one or more embodiments of the invention.

FIG. 5 is a schematic diagram illustrating the components of the server application that are used to implement model creation functionality, as well as a workflow for building a 3D model, in accordance with one or more embodiments of the invention.

FIG. 6 is a sequence diagram that illustrates the sequence of events that occur in the workflow when a user submits a model creation request to the server application for building a model, in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Overview

A web-based client-server platform provides the ability for users to create and modify a 3D (and/or 2D) model of an existing environment across a network using a full set of 2D and 3D tools. Currently, such models are typically manually constructed using pre-existing data.

Online data vendors, such as DataDoors™ (owned by i-Cubed) and WeoGeo™ (owned by Trimble), make available a web-based map interface that enables users to select areas of interest on the map, whereby they can purchase discrete sets of raw data related to that selection. So, if a user selects an area the size of San Francisco, for example, they would probably have options to separately purchase and subsequently download terrain data, satellite imagery, roads and infrastructure vectors, and other data for San Francisco. It would then be up to the user to do something with that raw data in the software platform of their choice.

Consumer mapping applications, such as Google Maps/Earth™ and Bing Maps™, pre-render Earth-based scenes and maps that customers can use to find specific locations, get directions, and overlay new information. However, the scenes and maps are usually not editable within these consumer mapping applications.

The present invention, on the other hand, provides automated model creation for use in infrastructure and city design applications. The present invention enables users to select an area on a 2D map displayed at a client computer and then submit a model creation request to a server computer, wherein the server computer aggregates various data sources, which may include both 2D and 3D data, to automatically generate a 3D model of the selected area. The 3D model is then stored for subsequent downloading to the client application, where it can be displayed, modified and shared by the user.

The key here is that, unlike online data vendors, the model creation of the present invention does not simply supply users with a set of raw data; rather, it automatically builds a complete 3D model from aggregated sources. And, unlike consumer mapping applications, the model creation of the present invention provides fully editable 3D models that are owned by the user.

### Hardware and Software Environment

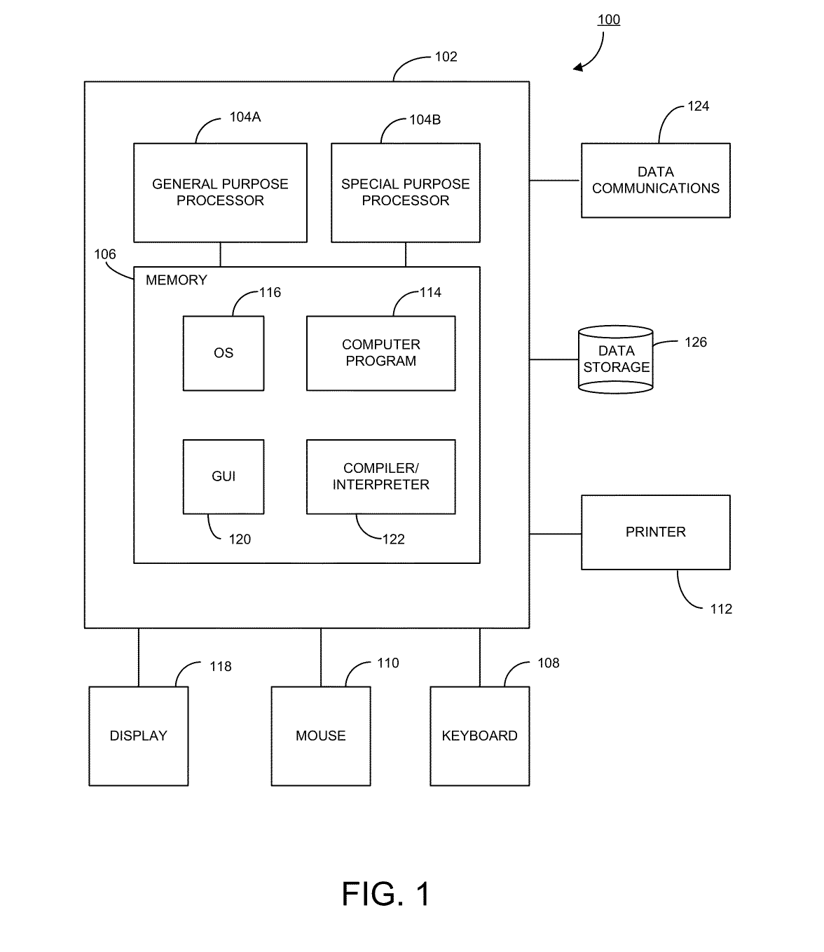

FIG. 1 is an exemplary hardware and software environment 100 used to implement one or more embodiments of the invention. The hardware and software environment includes one or more computers 102, wherein the computers 102 may be client computers or server computers. Each computer 102 may include a general purpose hardware processor 104A and/or a special purpose hardware processor 104B (hereinafter alternatively collectively referred to as processor 104) and a memory 106, such as random access memory (RAM). The computer 102 may be coupled to, and/or integrated with, other devices, including input/output (I/O) devices, such as a keyboard 108, a mouse or other cursor control device 110, and optionally a printer or other output device 112. In one or more embodiments, computer 102 may comprise any internet-enabled device.

In one embodiment, the computer 102 operates by the general purpose processor 104A performing instructions defined by the computer program 114 under control of an operating system 116. The computer program 114 and/or the operating system 116 may be stored in the memory 106 and may interface with the user and/or other devices to accept input and commands and, based on such input and commands and the instructions defined by the computer program 114 and operating system 116, to provide output and results.

Output/results may be presented on a display 118 or provided to another device for presentation or further processing or action. In one embodiment, the display 118 changes state to form all or part of an image in response to the data or information generated by the processor 104 based on the instructions of the computer program 114 and/or operating system 116. The image may be provided through a common graphical user interface (GUI) 120. Although the GUI 120 is depicted as a separate module, the instructions performing the GUI can be resident or distributed in the operating system 116, the computer program 114, etc.

Some or all of the operations performed by the computer 102 according to the computer program 114 instructions may be implemented in a special purpose processor 104B. In this embodiment, some or all of the computer program 114 instructions may be implemented via firmware instructions stored in a read only memory (ROM), a programmable read only memory (PROM) or flash memory within the special purpose processor 104B or in memory 106. The special purpose processor 104B may also be hardwired through circuit design to perform some or all of the operations to implement the present invention. Further, the special purpose processor 104B may be a hybrid processor, which includes dedicated circuitry for performing a subset of functions, and other circuits for performing more general functions such as responding to computer program 114 instructions.

The computer 102 may also implement a compiler/interpreter 122 that compiles the computer program 114 into processor 104 readable code for execution. Alternatively, the compiler/interpreter 122 interprets the computer program 114. When executed or interpreted, the computer program 114 accesses and manipulates data accepted from I/O devices and stored in the memory 106 of the computer 102 using the relationships and logic that were generated using the compiler/interpreter 122.

The computer 102 also includes a data communications device 124, for accepting input from, and providing output to, a data communications network. Using the network, the computer 102 may interact with other devices.

In one embodiment, instructions, logic and/or data implementing the operating system 108, the computer program 114, and the compiler/interpreter 122 are tangibly embodied in a non-transient computer-readable medium, e.g., a data storage device 126, which may be one or more fixed or removable data storage devices. Further, the operating system 108, the computer program 114, and the compiler/interpreter 122 are comprised of instructions, logic and/or data which, when accessed, read and executed or interpreted by the computer 102, cause the computer 102 to perform the steps necessary to implement and/or use the present invention or to load the program of instructions into a memory 106, thus creating a special purpose data structure causing the computer 102 to operate as a specially programmed computer executing the method steps described herein. The operating system 108, the computer program 114, and the compiler/interpreter 122 may also be tangibly embodied in memory 106 and/or accessible via the data communications device 124, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 102.

### Client/Server Architecture

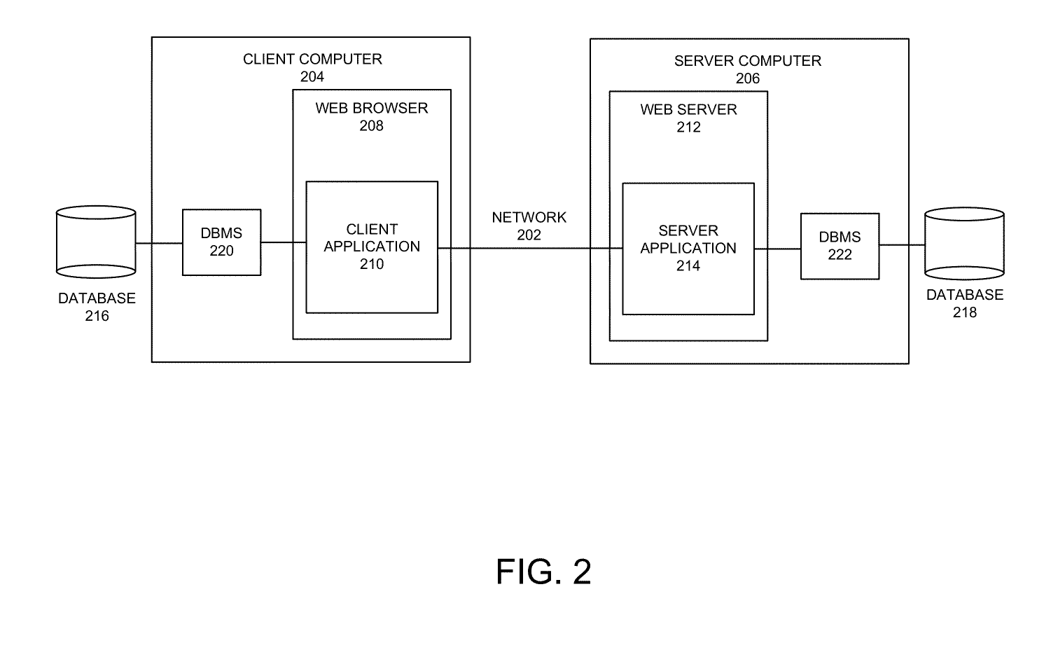

FIG. 2 schematically illustrates a typical distributed computer system 200 using a network 202 to connect one or more client computers 204 to one or more server computers 206. A typical combination of resources may include a network 202 comprising the Internet, LANs (local area networks), WANs (wide area networks), mobile networks, or the like; client computers 204 that are workstations, personal computers, laptops, tablets, smartphones, etc. (as set forth in FIG. 1); and server computers 206 that are mainframes, minicomputers, rack-mounted server appliances, workstations, personal computers, etc. (as set forth in FIG. 1).

Client computers 204 may execute a web browser 208, which in turn performs a client application 210, while server computers 206 may execute a web server 212, which in turn performs a server application 214. The server application 214 may be a software framework that provides both facilities to create web applications and to run them. The client application 210 may be downloaded from the server computer 206, as a script, plug-in, add-in or the like, for execution by the web browser 208. Alternatively, the client application 210 may comprise a desktop application, a mobile application, etc. Both the client application 210 and server application 214 may store data in their respective databases 216, 218 using their respective database management systems (DBMS) 220, 222.

Generally, in accordance with FIG. 1, components 202-206 are hardware and components 208-218 are software, wherein the hardware comprises electronic devices and the software comprises instructions, logic and/or data that is tangibly embodied in and/or retrievable from a device, medium, or carrier, e.g., a data storage device, a data communications device, a remote computer or device coupled to the computer via a network or via another data communications device, etc. Moreover, these instructions, logic and/or data, when read, executed, and/or interpreted, results in the functions and steps necessary to make and/or use the present invention. Of course, those skilled in the art will recognize that any combination of the above components, or any number of different components, may be used to implement the present invention.

### Modeling Application

In one or more of the embodiments of the invention, the client and server applications 210, 214 together comprise the Autodesk® InfraWorks 360® product, which includes a web-based modeling client application 210 downloaded to the client computer 204 from a cloud-based modeling server application 214 executed on the server computer 206.

InfraWorks® 360 is a transportation planning and design product that supports preliminary engineering for transportation projects, such as roadway design, bridge design and drainage design, with data-rich 3D models. Specifically, users can use InfraWorks®360 to combine and connect data to better create, view, analyze, share, and manage information to make decisions in context.

InfraWorks®360 includes a comprehensive set of product features:
Model creation. A 3D model can be automatically created, which involves accessing and incorporating large amounts of data to quickly model an existing environment.
Early-stage design. A user can create and sketch early design concepts within the model.
Advanced design. A user can extend their design capabilities with access to specialized applications and data for roadways, bridges, and drainage.
Collaboration. A user can publish and share the design, and gather feedback from stakeholders.

### Model Creation

InfraWorks®360 provides an automated server-based facility to create 3D models with data collected from multiple sources and file formats.

Within the InfraWorks®360 client application 210, the user selects a location, and then submits a request to the InfraWorks®360 server application 214 to automatically create a 3D model for the existing environment in the selected location using vector data, raster data, and data from other global sources. Specifically, InfraWorks®360 server application 214 incorporates vector data (points, lines, and polygons), raster data (a matrix of pixels organized into rows and columns), and data from 2D CAD (computer-assisted drafting) systems, other 3D models, GIS (geographic information systems), CityGML (a common information model for the representation of sets of 3D urban objects), point clouds (a set of data points in a coordinate system), etc., and multiple file formats, to create the 3D model. In a short amount of time, typically minutes, the user receives an email notification from the InfraWorks®360 server application 214 with a hyperlink giving them access to the model. The user then opens the model in the InfraWorks®360 client application 210 and begins working in the as-built environment of the 3D model.

### Early-Stage Design

InfraWorks®360 provides an intuitive user interface. A user can quickly access the appropriate tool for any type of work, and a user can complete a phase of work without having to change toolbars. A user can save additional time with contextual on-canvas access to the design details they need, when they need them.

InfraWorks®360 has sketching and layout capabilities. A user can add rich, lifelike details such as roads, bridges, and buildings that make their models and proposals more realistic and easier to understand.

InfraWorks®360 can quickly create multiple proposals. A user can more efficiently evaluate multiple alternatives using the data behind preliminary design concepts to better predict how alternatives may perform. A user can use proposals to explore alternatives for a given area within their model. Once the base model is constructed, a user can start developing design concepts by creating one or more proposals.

InfraWorks®360 includes theme palettes. A user can visually classify assets according to their attributes. For example, a user can highlight traffic emissions along streets and power usage of buildings. With InfraWorks®360, a user can use themes to visually classify terrain by elevation, slope, or aspect. Additionally, a user can classify point clouds by elevation and classify feature properties.

InfraWorks®360 also provides support for complex horizontal and vertical geometry.

### Advanced Design

InfraWorks®360 provides access to advanced design capabilities. For example, a user can invoke specialized applications and access specialized data for roadway, bridge and drainage design.

### Roadway Design

InfraWorks®360 performs road design in context. Roadway Design for InfraWorks 360® helps highway engineering professionals create data-rich models and engineer roadways in context. A user can streamline roadway geometry layout, including intersection design, with powerful, rules-based toolsets and analysis capabilities to help uncover potential impacts in the preliminary design phase. Advanced road and highway capabilities help civil engineering professionals working on transportation projects to explore preliminary design options and optimize project performance.

### Features and Benefits of Roadway Design Include:

Dedicated tools for roads and highways. A user can engineer roadways with tangents, curves, and spirals that are constrained by design criteria. Specialized features include:
   Style zones within road sections,
   Fixed-slope grading, and
   Fixed-width parametric grading.
Rules-driven intersection design. A user can use a data-rich model to streamline intersection geometry layout with discipline-specific authoring tools that incorporate parametric controls, support engineering standards, and provide design validation rules.
Standards-driven and dynamic road markings. A user can use design standards and configurable rules to define and modify stop and yield line locations and manually control median and road markings.
Rules-driven on/off ramps. A user can model interchanges with uninterrupted traffic flows using design standards and configurable rules for turning direction of intersecting roadways. A user can make manual changes to roadway ramps as desired.
Sight distance analysis. A user can identify sight distance failure zones, demonstrate desired and actual sight envelopes with informational tooltips. A user can identify driver sight obstructions and perform lane-by-lane analysis with road sight analytics.
Data exchange with the Autodesk® Civil 3D™ product. Intelligent roadway data such as horizontal alignments, vertical alignments, and intersections can be imported into Civil 3D™ with a simple workflow.
Data exchange from Civil 3D™. Complex horizontal and vertical geometry from Civil 3D™ is supported in InfraWorks®360, enabling corridors, alignments, and roadways to be brought back into InfraWorks®360 for visualization and collaboration.

### Bridge Design

InfraWorks®360 also improves the bridge design process. A user can explore preliminary design options more effectively by creating data-rich models and visualizing realistic civil structures in the context of the surrounding proposed site. Bridge Design for InfraWorks®360 helps simplify, accelerate, and focus the layout of girder bridge design concepts, and maintain consistent data and context.

### Features and Benefits of Bridge Design Include:

A user can create more realistic bridge structures in the context of the proposed roadway and explore options faster.
A comprehensive catalog of precast girders is provided.
A user can explore a wider range of precast concrete bridge design concepts with a comprehensive catalog of precast girders that reflect local construction practices.
A user can evaluate design options faster.
A user can simplify and accelerate the layout of girder bridges to more quickly investigate alternate solutions using a parametric workflow.
Data exchange with Civil 3D™. Preliminary bridge designs can be imported into Civil 3D™ as AutoCAD® solids to be used as a starting point for detailed design.
Data exchange from Civil 3D™. Complex horizontal bridge and roadway geometry in Civil 3D™ can be imported back into InfraWorks®360 for visualization and collaboration.

### Drainage Design

Drainage Design for InfraWorks®360 helps civil engineers accelerate roadway drainage design and analysis. A user can take advantage of the robust, data-rich model created in InfraWorks®360, built-in design standards, and cloud computing to automate processes, improve design accuracy, and better understand drainage impacts of road design in less time.

### Features and Benefits of Drainage Design Include:

Specialized tools for drainage design can help improve effectiveness and efficiency when analyzing watersheds and automating culvert design and layout of pavement drainage.
Watershed analysis cloud services. A user can delineate watersheds and streams across large terrain surfaces. A user can examine terrain to find watersheds and calculate peak flow values for use in cross-drainage design.
Standards-driven culvert design. A user can rapidly place, size, and compute cross-drainage designs. Analysis-driven rules determine culvert solution. Designs are resized for culvert configuration changes.
Automated drainage layout. A user can quickly model and modify drainage networks. A user can edit design rules and modify design (inlets and manholes).
Drainage catalog and quantities. A user can access an extended library of drainage features including manholes and inlet types. A user can create early estimates of component costs including culverts, inlets, manholes, and pipe.
Inlet and pipe design. Analysis-driven workflow where model context drives the analysis and heuristics for inlet, manhole and pipe design.
Outfalls design. User-controlled path for drainage piping and outfalls for customized network layouts.
Culvert reporting. A user can generate culvert design and analysis reports and distribute to stakeholders. A user can improve understanding, gain critical buy-in, or analyze preliminary designs to make better decisions earlier.
Data exchange with Civil 3D™. Support for complex Civil 3D™ geometries. Import Civil 3D™ pavement drainage networks to InfraWorks®360 for visualization and analysis.
Data exchange from Civil 3D™. Intelligent pipe network data such as horizontal and vertical alignments can be imported into Civil 3D™ with a simple workflow.

### Collaboration

InfraWorks®360 also provides cloud-based collaboration. Users can share models on a shared network drive.

InfraWorks®360 manages and publishes models. Users can publish, store, and manage large models centrally and more securely in the cloud, fostering project team collaboration. Users can share all or select portions of their model with a wider audience, including public and project stakeholders.

InfraWorks®360 allows users to collaborate with multiple stakeholders by inviting team members to access, download, and edit shared models simultaneously and review multiple project proposals using the same data.

InfraWorks®360 allows access to models for viewing via the web and mobile devices, as well as PCs. For example, InfraWorks®360 provides field access to infrastructure models and select portions of the model to share with a diverse group of stakeholders.

InfraWorks®360 allows users to view projects in the context of existing conditions. Specifically, near-realistic visual effects better communicate design concepts with near-photorealistic rendering tools that add dynamic sun and shadows, more realistic water, and animated clouds. Visual effects tools enable users to interactively alter the display of their model.

InfraWorks®360 provides for real-time feedback on models. With a Design Feed feature, public stakeholders can provide comments on projects as they are developed using their web browser or mobile device. As a result, stakeholders can stay more informed and engaged, helping to accelerate the approval process.

### Model Creation User Experience Flow

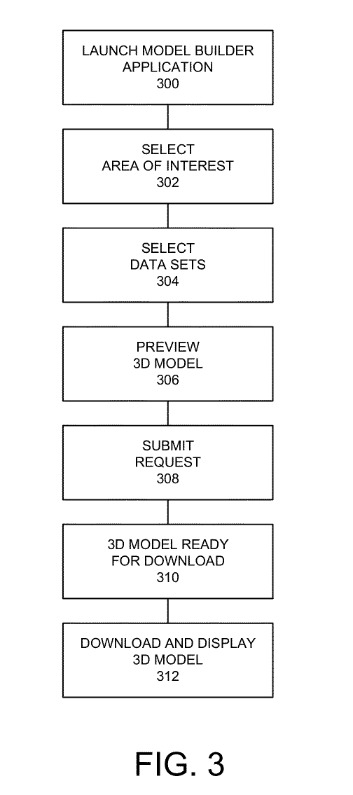

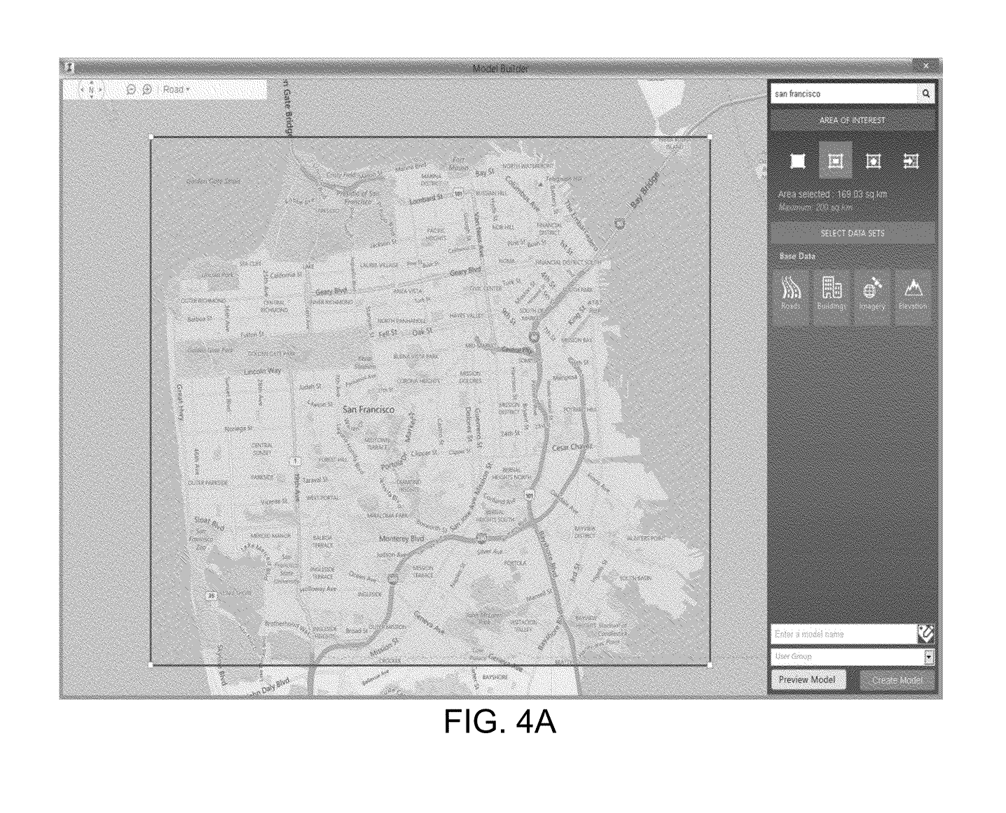

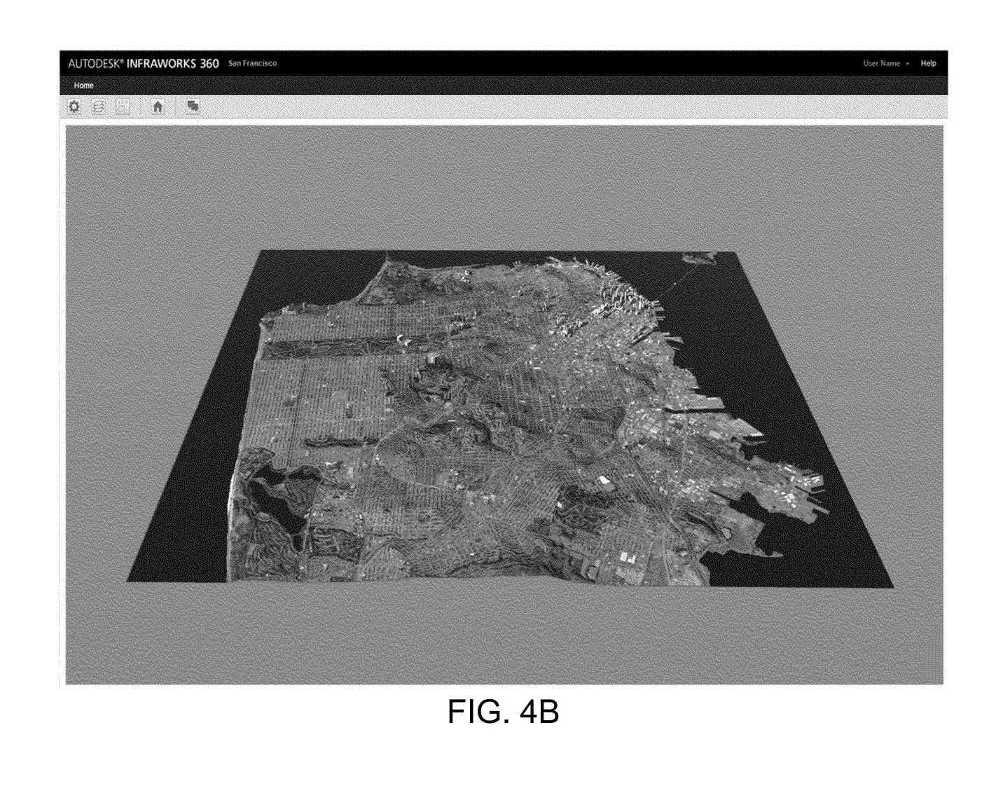

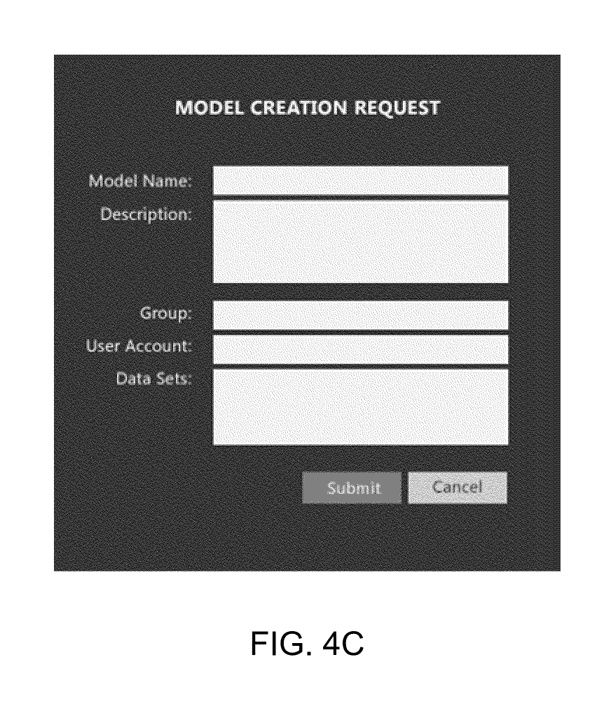

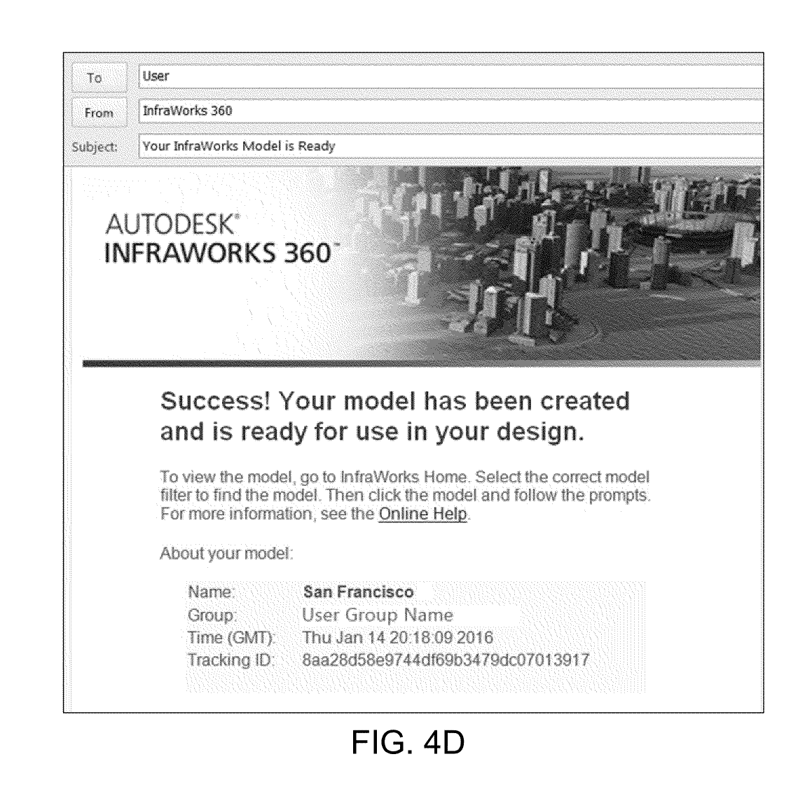

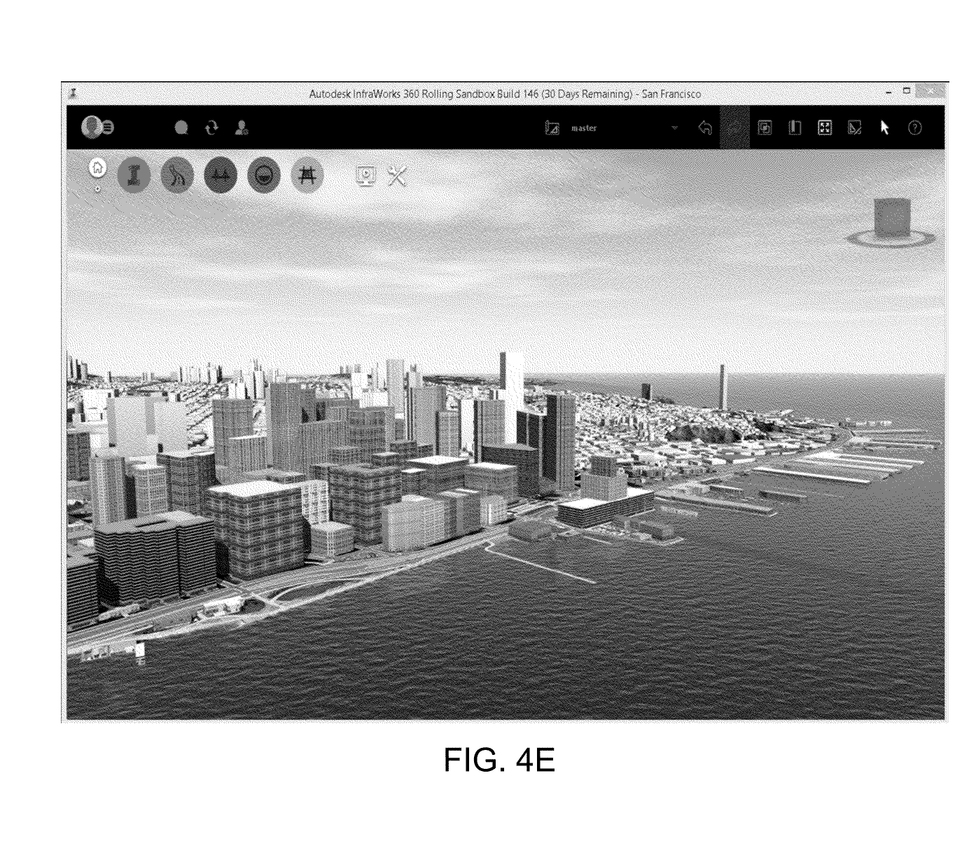

FIG. 3 is a flowchart illustrating the user experience flow within the InfraWorks®360 client application 210 for model creation, in accordance with one or more embodiments of the invention. FIGS. 4A-4E illustrate the graphical user interfaces (GUIs) displayed by the InfraWorks®360 client application 210 during that user experience flow.

Block 300 represents the step of a Model Builder app being launched within the InfraWorks®360 client application 210, typically when a web page containing the app is downloaded from the InfraWorks®360 server application 214.

Block 302 represents the step of the user searching for a desired geolocation on a 2D map displayed by the InfraWorks®360 client application 210, and then selecting a Area Of Interest (AOI) by drawing a polygon around the AOI using the InfraWorks®360 client application 210. FIG. 4A illustrates the graphical user interface displayed by the InfraWorks®360 client application 210 at that step of the user experience flow, wherein the AOI is the highlighted area within the polygon (i.e., square).

Block 302 also represents the step of the user selecting the desired data sets from the rightmost panel displayed by the InfraWorks®360 client application 210, wherein the data sets may include data such as USGS and SRTM terrain data, OpenStreetMap (OSM) streets data, Bing imagery data, as well as other data from other providers. FIG. 4A again illustrates the graphical user interface displayed by the InfraWorks®360 client application 210 at that step of the user experience flow, wherein each of the data sets is listed in the rightmost panel and include, in this example, Base Data, such as Roads, Buildings, Imagery, and Elevation, but could include other data sets, such as premium data, as well.

Block 306 represents the step of the user previewing a 2D model for the selected AOI using the InfraWorks®360 client application 210, before placing an order for the 3D model. FIG. 4B illustrates the graphical user interface displayed by the InfraWorks®360 client application 210 at that step of the user experience flow, wherein a preview of the model is shown and the AOI is displayed in a plan view showing elements within the AOI.

Block 308 represents the step of the user submitting a model creation request for a 3D model of the selected AOI from the InfraWorks®360 client application 210 to the InfraWorks®360 server application 214. FIG. 4C illustrates the graphical user interface displayed by the InfraWorks®360 client application 210 at that step of the user experience flow, wherein a dialog box for the model creation request includes fields for entering a model name, description, group, user account, and a list of desired data sets to use.

Block 310 represents the step of the user receiving a notification from the InfraWorks®360 server application 214, typically via email in the InfraWorks®360 client application 210, that the 3D model created for the selected AOI is ready for downloading. FIG. 4D illustrates the graphical user interface displayed by the user's email application at that step of the user experience flow, wherein the email message is displayed.

Block 312 represents the step of the user downloading and displaying the 3D model created for the selected AOI from the InfraWorks®360 server application 214 to the InfraWorks®360 client application 210. FIG. 4E illustrates the graphical user interface displayed by the InfraWorks®360 client application 210 at that step of the user experience flow, wherein the 3D model is displayed in a perspective view showing the elements within the selected AOI.

Thereafter, once the 3D model created for the selected AOI has been downloaded and displayed, Block 312 may also represents the step of the user updating, modifying and altering the 3D model created for the selected AOI using the InfraWorks®360 client application 210. This may also represent the user performing any of steps 300-310 again, for example, to request new data sets to update the 3D model, or other steps, for example, by manually editing the 3D model.

### Model Creation Workflow

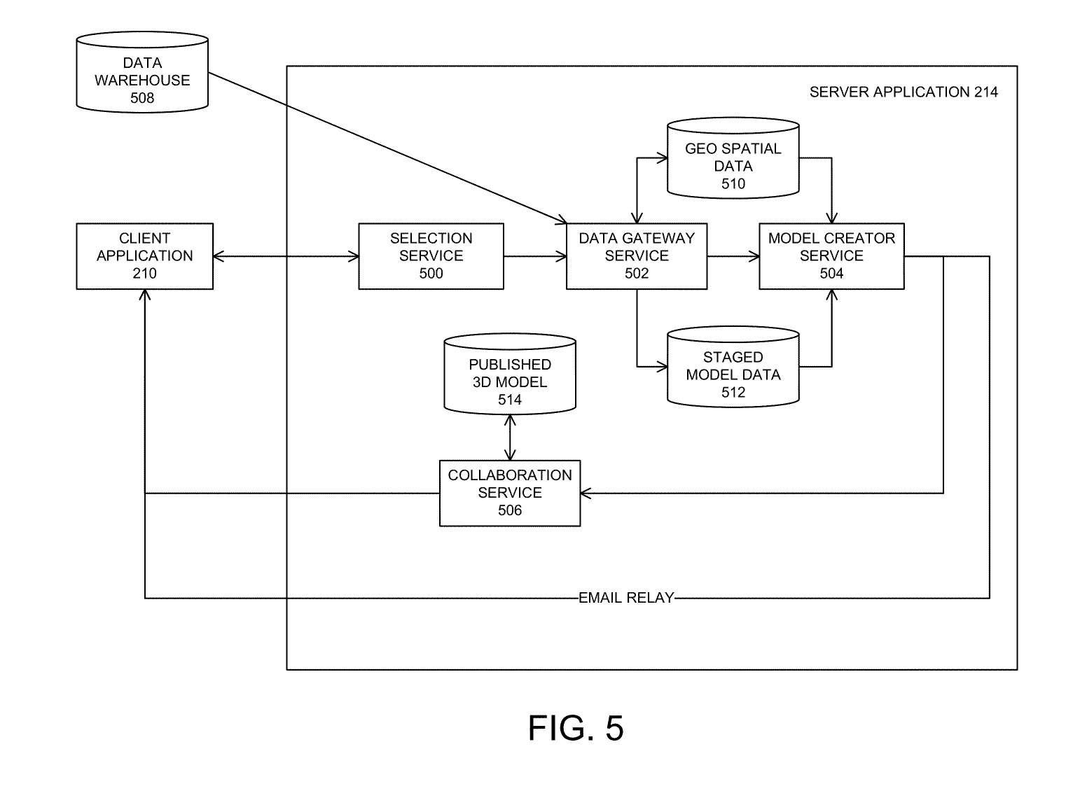

FIG. 5 is a schematic diagram illustrating the components of the InfraWorks®360 server application 214 that are used to implement the model creation functionality, as well as the workflow for building a 3D model, in accordance with one or more embodiments of the invention. Specifically, the InfraWorks®360 server application 214 includes a Selection Service 500, Data Gateway Service 502, Model Creator Service 504, and Collaboration Service 506, and interfaces to one or more external Data Warehouses 508.

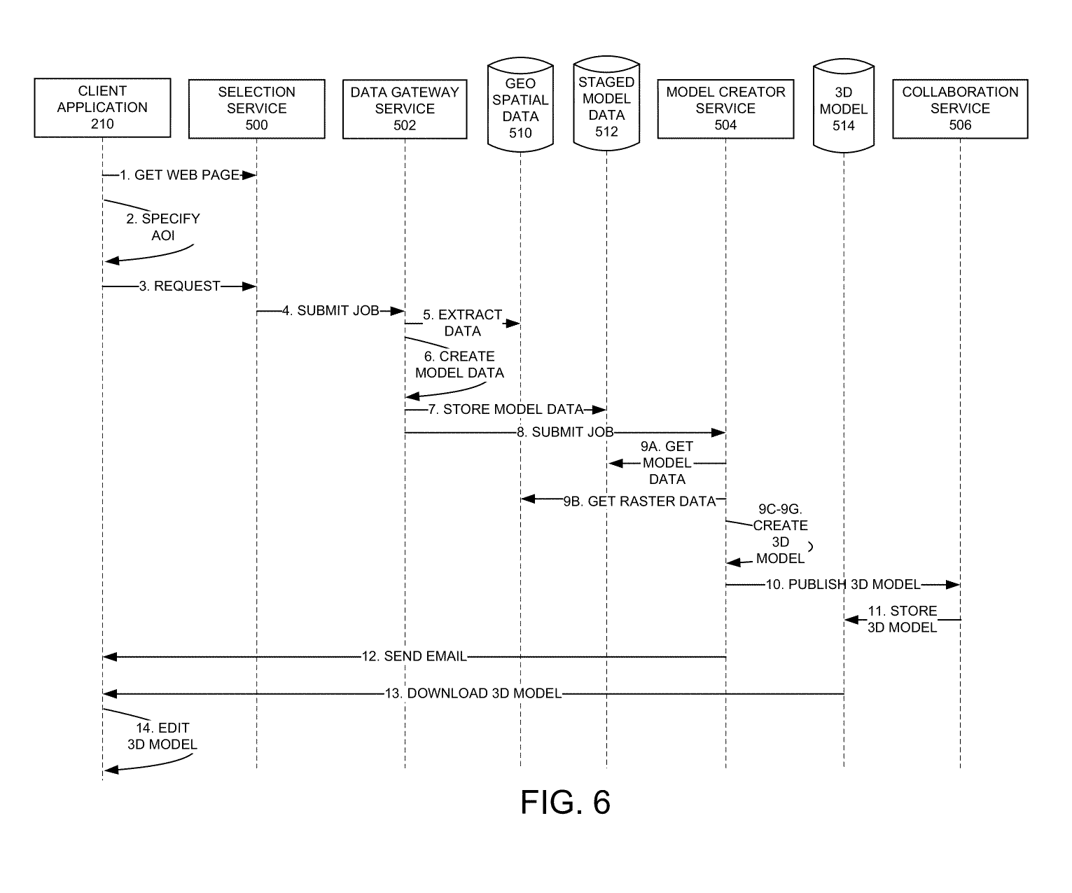

FIG. 6 is a sequence diagram that illustrates the sequence of events that occur in the workflow when a user submits a Model Creation Request to the InfraWorks®360 server application 214 for building a 3D model, in accordance with one or more embodiments of the invention.

More specifically, the workflow for building the 3D model in response to a user request includes the following steps:
1. The InfraWorks®360 client application 210 executes the Model Builder app, wherein the Model Builder app is associated with, and invoked by, downloading a web page from the InfraWorks®360 server application 214.
2. The user searches for the desired geolocation on the 2D map displayed by the InfraWorks®360 client application 210, and then selects the AOI, for example, by drawing a polygon around the AOI using the InfraWorks®360 client application 210. This step may also include the user selecting the desired data sets for the 3D model, as well as the user previewing the 3D model for the selected AOI.
3. The user then submits the Model Creation Request for the 3D model for the selected AOI to the InfraWorks®360 server application 214, where it is received by the Selection Service 500. The Model Creation Request is a package containing data that identifies the AOI selected by the user, for example, a bounding polygon in World Geodetic System 1984 (WGS84) coordinates, which is a standard for use in cartography, geodesy, and navigation including by GPS, along with desired model name and description, target group to publish the model, user account information, and the desired data sets to use.
4. The Selection Service 500 builds a job that is submitted to the Data Gateway Service 502 for execution.
5. In executing the job, the Data Gateway Service 502 then performs the following steps:
A. Accesses a geospatial database 510, which is a database curated by Autodesk, Inc., the assignee of the present invention, that pre-aggregates available source data, in that its contents have been selected, organized, and presented using professional or expert knowledge, specifically for the InfraWorks®360 product and contains, for example, specialized data for roadway design, bridge design, and drainage design, as well as other specialized data;
B. Builds one or more spatial queries to extract vector data for features within the AOI from the geospatial database 510, wherein the vector data may include data for:
   Roadways,
   Bridges,
   Drainage,
   Buildings,
   Railways,
   Waterways,
   Water area polygons,
   Water area multi-polygons,
   Land-use polygons,
   Land-use multi-polygons, and
   Coastline and ocean polygons; and
C. Builds one or more spatial queries to identify paths to raster data for features within the AOI stored in the geospatial database 510, wherein the raster data may include aerial and/or terrain raster tiles within the AOI.
6. The Data Gateway Service 502 packages the vector data along with the paths to the raster data to create the model data.
7. The Data Gateway Service 502 stores the model data in a staged model database 512.
8. The Data Gateway Service 502 creates a job, and submits it to the Model Creator Service 504.
9. In executing the job, the Model Creator Service 504 performs the following steps:
   A. Unstages the previously staged model data from the staged model database 512;
   B. Downloads all the referenced raster data from the geospatial database 510;
   C. Creates a local empty 3D model;
   D. Uses data import to import the vector data and/or one or more layers of the raster data into the 3D model; and
   E. Stylizes the vector and/or raster data in the 3D model.
   F. Optionally, data from the external Data Warehouses 508 may be included in the 3D model.
   G. The result of these steps is a 3D model created using the extracted data.
10. Upon completion, the Model Creator Service 504 publishes or uploads the 3D model to the Collaboration Service 506
11. The Collaboration Service 506 stores the 3D model in a database 514.
12. Finally, the Model Creator Service 504 sends the user an email indicating their 3D model is ready to download.
13. The InfraWorks®360 client application 210 downloads the 3D model from the database 514, which is managed by the Collaboration Service 508, where it can then be displayed using the InfraWorks®360 client application 210.
14. Thereafter, once the 3D model created for the selected AOI has been downloaded and displayed, the user may edit, update, modify, alter, etc., the 3D model created for the selected AOI using the InfraWorks®360 client application 210. Specifically, the 3D model is a proprietary model owned by the user, fully automated with applicable metadata, and fully editable by the user. The user can manipulate the 3D model, e.g., take out buildings, add new buildings, add roads, dig in the earth and build tunnels, etc. The user may also add other data (free or purchased) to the 3D model, for things like roadways, bridges, drainage, etc. The end result is a 3D model that can be utilized in a

### CONCLUSION

This concludes the description of the preferred embodiment of the invention. The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims filed with any utility application based hereon.

1. A system for automatically creating a three-dimensional (3D) model for use in a design application, comprising:
a server computer coupled via a communications network to one or more client computers, wherein:
at least one of the client computers enables a user to select an area of interest on a two-dimensional (2D) map displayed at the client computer and then to submit a model creation request for the area of interest to the server computer; and
the server computer automatically aggregates one or more data sources, which include both 2D and 3D data, to generate a 3D model of the area of interest, wherein the 3D model is stored for subsequent downloading to the client computer, where it can be displayed, modified and shared by the user.

2. The system of claim 1, wherein the 3D model supports preliminary engineering for transportation projects, such as roadway design, bridge design or drainage design.

3. The system of claim 1, wherein the 3D model is a proprietary model owned by the user, and is editable by the user.

4. The system of claim 1, wherein the at least one of the client computers enables a user to select one or more data sets to be used by the server computer in creating the 3D model of the area of interest.

5. The system of claim 1, wherein the model creation request identifies the area of interest using a bounding polygon in World Geodetic System 1984 (WGS84) coordinates.

6. The system of claim 1, wherein the at least one of the client computers enables a user to preview the 3D model of the area of interest before submitting the model creation request for the area of interest to the server computer.

7. The system of claim 1, wherein at least one of the data sources comprises a curated database, the contents of which have been selected, organized, and presented using professional or expert knowledge.

8. The system of claim 7, wherein the curated database contains specialized data for roadway design, bridge design, or drainage design.

9. The system of claim 1, wherein the server computer builds one or more spatial queries to extract vector data for features within the area of interest from a geospatial database.

10. The system of claim 9, wherein the vector data includes data for: roadways, bridges, drainage, buildings, railways, waterways, water areas, land-use areas, coastlines or oceans.

11. The system of claim 1, wherein the server computer builds one or more spatial queries to identify raster data for features within the area of interest stored in a geospatial database.

12. The system of claim 11, wherein the raster data includes aerial or terrain raster tiles within the area of interest.

13. The system of claim 1, wherein the server computer creates an empty 3D model, imports vector data and/or one or more layers of raster data into the empty 3D model, and stylizes the vector data or raster data in the 3D model.

14. The system of claim 13, wherein the server computer includes other data from external data sources into the 3D model.

15. The system of claim 1, wherein the server computer publishes or uploads the 3D model, which stores the 3D model in a database, from which the 3D model is subsequently downloaded to the client computer.

16. A method for automatically creating a three-dimensional (3D) model for use in a design application, comprising:
coupling one or more client computers to a server computer via a communications network, wherein:
at least one of the client computers enables a user to select an area of interest on a two-dimensional (2D) map displayed at the client computer and then to submit a model creation request for the area of interest to the server computer; and
the server computer automatically aggregates one or more data sources, which includes both 2D and 3D data, to generate a 3D model of the selected area of interest, wherein the 3D model is stored for subsequent downloading to the client computer, where it can be displayed, modified and shared by the user.

17. An article of manufacture comprising a program storage medium readable by a computer and tangibly embodying one or more instructions executable by the computer to perform a method for automatically creating a three-dimensional (3D) model for use in a design application, the method comprising:
coupling one or more client computers to a server computer via a communications network, wherein:
at least one of the client computers enables a user to select an area of interest on a two-dimensional (2D) map displayed at the client computer and then to submit a model creation request for the area of interest to the server computer; and
the server computer automatically aggregates one or more data sources, which includes both 2D and 3D data, to generate a 3D model of the selected area of interest, wherein the 3D model is stored for subsequent downloading to the client computer, where it can be displayed, modified and shared by the user.
